(19) United States
(12) Patent Application Publication
(10) Pub. No.: US 2023/0281478 A1
(43) Pub. Date: Sep. 7, 2023

(54) CONDITION MONITORING OF AN ELECTRIC POWER CONVERTER

(71) Applicant: Siemens Aktiengesellschaft, München (DE)

(72) Inventors: Ali Al Hage Ali, Erlangen (DE); Benjamin Amschler, Heinersreuth (DE); Dominik Zacharias, Fürth (DE); Johanna Westrich, München (DE)

(21) Appl. No.: 18/111,817

(22) Filed: Feb. 20, 2023

(30) Foreign Application Priority Data
Mar. 1, 2022 (EP) 22159479.9

(51) Int. Cl. G06N 5/022; G06F 1/28

(52) U.S. Cl. CPC G06N 5/022; G06F 1/28

(57) ABSTRACT

A computer-implemented method of providing a machine learning model for condition monitoring of an electric power converter is provided. The method includes: obtaining a first batch of input data that includes a number of samples of one or more operating parameters of the converter during at least one operating state of the converter; reducing the number of samples of the first batch by clustering the samples of the first batch into a first set of clusters, (e.g., according to a first clustering algorithm, e.g., based on a clustering feature tree, such as BIRCH), and determining at least one representative sample for each cluster; providing the representative samples for training the machine learning model; and/or training the machine learning model based on the representative samples.

The present patent document claims the benefit of European Patent Application No. 22159479.9, filed Mar. 1, 2022, which is hereby incorporated by reference in its entirety.

### TECHNICAL FIELD

The present disclosure relates to the field of electric power converters and to use of machine learning techniques for monitoring electric power converters.

### BACKGROUND

During the operation of a plant including one or more machines, changes occur over time that may not be recognizable to the plant operator. These changes may be caused by the mechanics of the machine(s) but may also have electrical reasons. This may lead to increased wear in the machine(s) or influence the produced quality of a product. If changes in the plant are not detected at an early stage, this may lead to increased downtime and additional or increased maintenance costs. A recognition of gradual changes may also be rather subjective, e.g., based on the individual assessment of a respective plant operator.

Technically complex relationships, such as the correlation and the detection of changes with regard to a large number of simultaneously relevant process parameters, may hardly be monitored and correctly assessed by the plant operator. For example, changes in a drive system, (including an electric power converter, a motor, and/or transmission), and/or in the actual process, may therefore only be detected when the change has become noticeable, e.g., in the form of a shutdown and/or a quality defect. The monitoring functions and analysis options available in the converter partly provide active protection and may serve for detecting problems occurring in the plant. However, the analysis is only performed retroactively and not during the occurrence of the damage.

Due to the amount of data required for a detailed assessment of the condition of the drive system, a correspondingly large amount of computing power and data storage has been required so far. Up until now, the evaluation could thus not be carried out close to the drive system, but was possibly carried out in computing units, which did not possess a direct high-frequency access to the data at the field level of the plant.

Through regular manual inspection and continuous maintenance of the plant components, the condition of the plants and machines is monitored today. In most cases, changes or problems are only detected when machines and systems have failed. The manual error analysis thus only begins when the problem has already occurred, and possibly high costs have arisen due to machine and plant downtime. In addition, the experience of the maintenance and service personnel plays a decisive role in an analysis.

International patent application PCT/EP2021/069728 discloses a method of optimizing a control loop of a converter, the method including: acquiring actual values of a drive system powered by the converter; inferring, based on at least one machine learning model and the actual values, one or more adjustments of control parameters of the control loop for improving the control accuracy; and outputting the adjustments for adapting the control parameter values.

Furthermore, it is disclosed in European patent application EP21200255 to improve the monitoring of a machine by providing training data of several nominal operating states of the machine and to cluster the training data according to the operating states of the machine and to train a classifier that assigns the operating states to the clustered training data.

### SUMMARY

In any case, the amount of data that is obtained during the operation of the drive system, and the converter in particular, may become too large and/or unbalanced. In addition, present-day converters and/or other process-level components may not possess sufficient computing and/or storage capability to handle the data in a timely manner.

It is therefore an object of the present disclosure to improve the data handling for monitoring a drive system and a converter in particular. It is a further object of the present disclosure to improve the accuracy when it comes to determining an abnormal operation in the operation of a converter or drive system in general.

According to a first aspect, the object is achieved by a computer-implemented method of providing a machine learning model for condition monitoring of an electric power converter. The method includes obtaining a first batch of input data, wherein the input data includes a plurality of samples of one or more operating parameters of the converter during at least one operating state of the converter. The method further includes reducing the number of samples of the first batch by clustering the samples of the first batch into a first set of clusters, (e.g., according to a first clustering algorithm, e.g., based on a clustering feature tree, such as BIRCH). The method further includes determining at least one representative sample for each cluster. The method further includes providing the representative samples for training the machine learning model and/or training the machine learning model based on the representative samples.

According to a second aspect, the object is achieved by the use of the trained machine learning model according to the first aspect.

According to a third aspect, the object is achieved by a trained machine learning model obtained by the acts of the first aspect.

According to a fourth aspect the object is achieved by a device, e.g., including a first and/or a second memory unit, operative to perform the acts according to the first aspect.

The scope of the present disclosure is defined solely by the appended claims and is not affected to any degree by the statements within this summary. The present embodiments may obviate one or more of the drawbacks or limitations in the related art.

### BRIEF DESCRIPTION OF THE DRAWINGS

FIG. 1 shows a schematic illustration of an example of a converter powering a drive system.

FIG. 2 shows a table including a plurality of operating parameters of a converter.

FIG. 3 shows an illustration of an example of input data divided into a plurality of batches.

FIG. 4 shows an illustration of an example of a first set of clusters and representative samples of each cluster.

FIG. 5 shows all samples of an example of the input data and representative samples of the input data obtained by data reduction.

FIG. 6 shows exemplary method acts of incremental preprocessing, data reduction, and/or re-sampling for training a machine learning model.

FIG. 7 shows representative samples of an example of the input data to which additional samples are added (re-sampled).

FIG. 8 shows exemplary method acts when applying the machine learning model.

FIG. 9 shows an illustration of an example of an anomaly score as output by the machine learning model and a pre-determined threshold.

FIG. 10 shows an example of a device including a processing unit and a first and a second memory.

### DETAILED DESCRIPTION

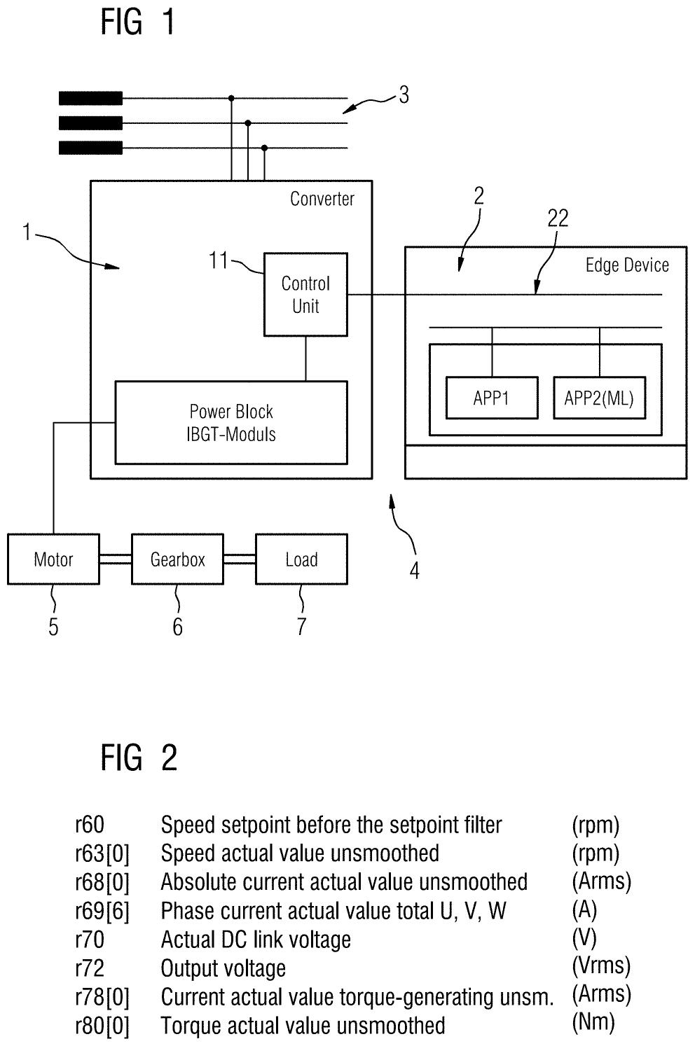

In FIG. 1, an electric power converter 1, (also denoted as converter in the following), and a drive system 4 are shown. The control of the drive system 4 is performed by the converter 1 and a control unit 11 (e.g., integrated into the converter 1). To that end, the converter 1 is part of a control loop and may include a processor and a memory to control the drive system 4. The converter 1 is configured to power a motor 5 of the drive system 4. The drive system 4 may thus include the converter 1, which is coupled to a line voltage 3. The drive system may further include the motor 5. A gearbox 6 may be coupled to the motor 5. The gearbox 6 may be coupled to a load 7, e.g., for performing one or more process acts in the production of a product. Alternatively, the motor 5 may be directly coupled to the load 7. The control unit 11 of the converter 1 controls one or more insulated-gate bipolar transistors (IGBT) of a power block, which serve as electronic switches for providing electric energy to the motor 5.

The converter 1 is connected to an edge device 2. To that end, the control unit 11 of the converter 1 may be connected to a data bus 22 via which the one or more operating parameters of the converter are transmitted. The edge device 2 may include one or more analytics software applications, APP1, APP2, (e.g., including a machine learning model ML), for processing the data obtained from the converter 1. Hence, the control unit 11 may provide input data to the one or more analytics software applications of the edge device 2. The edge device 2 may serve for providing connectivity of the converter 1 with a higher-level system such as a cloud computing system, not shown, and/or the edge device 2 may serve as an on-site computing unit for processing the input data provided by the converter 1. The data bus 22 is part of the edge device 2 and may be coupled to the converter 1 via respective interfaces of the converter 1 and the edge device 2. The analytics software applications APP1, APP2 may be executed on an operating system OS, (e.g., Linux), of the edge device 2.

The proposed solution is capable of monitoring the drive system 4 including the application specific usage of the drive system 4 and the converter 1, respectively. Existing data from the converter 1 is used, which means that no additional measuring sensors are required. This data is then used to detect anomalies in the drive system 4 and to determine deviations from a normal operating state. For anomaly detection, two phases are necessary. The first phase, (e.g., the training phase), performs data preprocessing, feature extraction, and model training. The second phase, (e.g., the application phase), describes the productive use, also including data preprocessing, feature extraction, and final anomaly detection.

FIG. 2 shows a table including a plurality of operating parameters of a converter. The analytics software application APP1, APP2 may detect changes in the operation of the drive system, in particular the converter, which may be harmful or lead to a lower performance or quality of the production or product. The operating parameters of the converter as shown in FIG. 2 may be used to detect these anomalies. The operating parameters may be identified using a variable name, such as given in the first column of FIG. 2, e.g., the speed setpoint is identified by the variable name r60. The operating parameters may possess a physical unit in which they are measured or otherwise obtained, e.g., the speed setpoint is given in revolutions per minute (rpm). Other operating parameters such as the “absolute current actual value unsmoothed” may be given in Ampere root mean square (Arms) or in case of the “torque actual value unsmoothed” in Newton meter (Nm). The operating parameters may be provided in a data format such as float, e.g., FloatingPoint32, or the like and/or may be provided by the converter 1, e.g., via the control unit 11 and the data bus 22 to the analytics software application APP1, APP2, as e.g., shown in FIG. 1.

Now, the converter may provide the operating parameters, e.g., every few milliseconds (ms), such as every 250 ms. This high data rate leads to a significant amount of data, e.g., data volume, which has to be stored and processed by the edge device 2 and/or the respective analytics software applications APP1, APP2. Additionally, more than one converter, e.g., a plurality of converters may be coupled to the edge device and these converters may transmit their respective operating parameters to the (e.g., same) edge device.

Hence, a method is needed that allows for processing the large amount of data by the edge device and the respective analytics software applications. It is thus proposed to process the input data obtained from the converter 1 successively in a batch-wise manner.

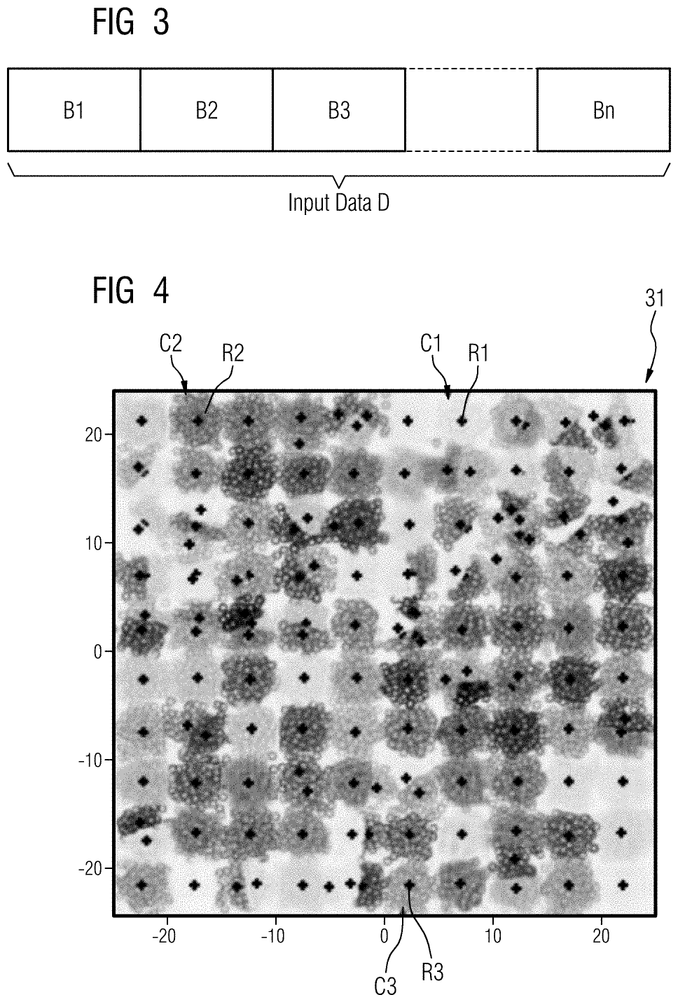

FIG. 3 shows an illustration of input data D divided into a plurality of batches B1, B2, . . . , Bn. The input data D may include a so called fingerprint, e.g., reference values that serve as a baseline for the operation of the converter. The input data D may include as outlined in the above one or more of the operating parameters of the converter. The analytics software application may include a machine learning model that utilizes this reference data of the converter, which may represent a healthy, normal condition, for training, e.g., during a training phase. The fingerprint of the operation of the converter is included in the input data D and may include several operating states and include several signals/parameters from the converter and/or drive system. Anomalies hence represent deviations from this fingerprint.

The recording of the fingerprint may be started, for example, by a user using a user interface. The recording time of the fingerprint may include multiple or all possible working points of the drive system and the converter, respectively. It is thus necessary that the fingerprint includes sufficient operating states, e.g., for the analytics software application to work properly.

As mentioned herein, for the recognition of the condition of the drive system a reference measurement, called fingerprint, is recorded. This fingerprint should span a period of time that is significant enough for the operation of the drive system and its application. All operating states typical for the application are part of this fingerprint. The start time and the duration of the fingerprint may be set by the user, e.g., the plant operator. For example, the time range may be from six hours to two weeks depending on the application to monitor. Based on the fingerprint, a machine learning model is created and may be stored, for example, on the edge device. Later, a new fingerprint may be recorded and used to update and retrain the machine learning model by selecting a new start time and duration. The recording of the fingerprint is based on raw data from the converter, which raw data may be saved in the database for a predetermined period of time. The more constant the operating states of the drive system are while the fingerprint is being recorded, the easier it is for the machine learning model to learn these operating states. As a result, the anomaly detection works more accurately and reliably.

Due to limitations of the hardware of the edge device, the duration of the fingerprint which may be processed and/or used for training of a machine learning model may be limited. In any case, the user may still specify the duration of the fingerprint as usual. However, if the size of the dataset resulting after preprocessing exceeds a predefined limit, e.g., 65,000 samples, the machine learning model will be only trained using the first 65,000 samples of processed data. The analytics software application may output, e.g., display on a user interface, the actual time range trained. For a motor which runs in only two operating states a predefined limit of, e.g., 65,000, samples will not be reached in two weeks of training. But for an application which runs in different operating states every minute, a predefined limit of samples, (e.g., 65,000 samples), may be reached within two days.

If not all operating states typical for the application of the drive system are covered by the fingerprint, the analytics software application may detect a multitude of anomalies, e.g., because a specific operating state is not known by the machine learning model.

Once the machine learning model has been trained, the machine learning model of the analytics software application may be used for inference or prediction, e.g., determining an abnormal operation and/or anomaly of the converter, e.g. based on an anomaly score output by the machine learning model. During this application phase new input data may be obtained from the converter which is used by the machine learning model for inference or prediction. As shown in FIG. 3 the input data may also be divided into one or more partitions, e.g. a plurality of batches.

As shown in FIG. 3, the input data D may be divided into batches of equal size, e.g., containing the same amount of data. However, one or more batches may also include a different amount of data. As will be described later in more detail, the input data D may be stored in a first memory of the edge device, whereas the individual batches B1, B2, B3, . . . Bn are transmitted and successively stored in a second memory of the edge device. For that matter, a batch stored in the second memory may at least partially be overwritten once a new batch is obtained by the second memory. In order to store the input data D, the first memory possesses a storage capacity to store the input data and the amount of data of the input data is pre-set to be lower than the storage capacity of the first memory, respectively. Furthermore, the storage capacity of the second memory is lower than the one of the first memory and the data volume of the one or more batches is such that it may be stored on the second memory. As will be seen later, cf. FIG. 10, the second memory serves as a working memory of a processor that processes the one or more batches successively, e.g., in order to train a machine learning model (during the training phase) or to determine an abnormal operating state or anomaly (during the application phase). The first memory may be a non-volatile memory whereas the second memory is a volatile memory.

The input data D, as shown in FIG. 3, may correspond to the above mentioned fingerprint. This fingerprint serves as a reference measurement and includes reference conditions that may be understood as normal, e.g., normal operating state(s) of the converter and/or normal range of operating parameters of the converter. The analytics software application utilizes a reference measurement of the drive system and/or converter, respectively, as a baseline which may represent the healthy normal conditions of the drive system and/or the converter. The fingerprint may cover several operating states and include several operating parameters of the drive system and/or the converter, respectively. Anomalies or abnormal operating states represent deviations from this baseline condition.

FIG. 4 shows an illustration of a first set 31 of clusters C1, C2, C3 and representative samples R1, R2, R3 of each cluster C1, C2, C3. In order to reduce the amount of data of the input data and the one or more batches, a data reduction is performed. To that end, the samples contained in a batch, e.g., the first batch, are clustered and a representative sample for each cluster is determined. Hence, a cluster includes one or more samples of the batch. The one or more clusters may be created by a clustering algorithm such as BIRCH, balanced iterative reducing and clustering using hierarchies. BIRCH is a memory-efficient, learning method which iteratively builds a tree data structure (clustering feature tree CFT) where the data, e.g., the samples, is compressed to a set of clustering feature nodes (CF nodes). The input data and the batch(es), respectively, are reduced to a first set 31 of clusters obtained directly from the leaves of the tree. The BIRCH algorithm uses this tree structure to create clusters. It may be referred to as the Clustering Feature Tree (CF Tree). Each node of this tree is composed of several Clustering features (CF).

For each cluster C1, C2, C3, a representative sample R1, R2, R3 is determined. Thereby, the information content of the cluster C1, C2, C3 is condensed from multiple samples to a single sample R1, R2, R3 or a lower amount of samples. For example, the centroid of the samples of a cluster C1, C2, C3 may be determined and used as a representative sample R1, R2, R3.

The process of clustering may be performed multiple times, e.g., for each batch the clusters and the cluster tree, respectively, is updated. Finally, the input data and all of the batches, respectively, are processed using the first clustering algorithm. Then, a representative sample may be determined for each cluster.

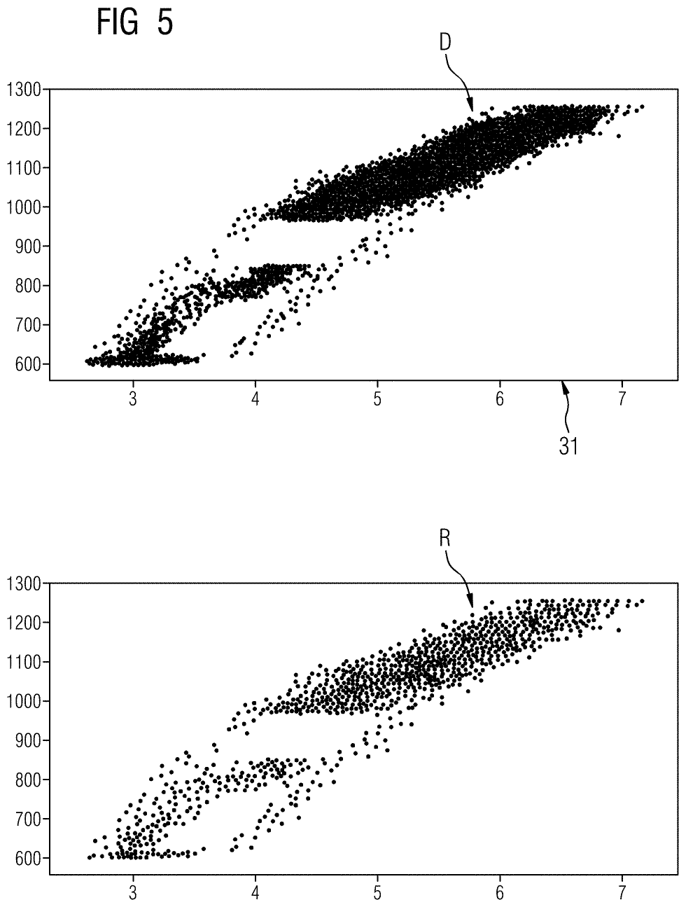

FIG. 5 shows all samples of the input data D and representative samples R of the input data D obtained by data reduction. In the first image of FIG. 5, all samples of the input data D are illustrated. Therein, sample bulks are present where samples are agglomerated. The second image shows the representative samples R of the input data D, e.g., obtained as described above, by reducing the number of samples. As may be seen the sample bulks are resolved and the samples are thinned out.

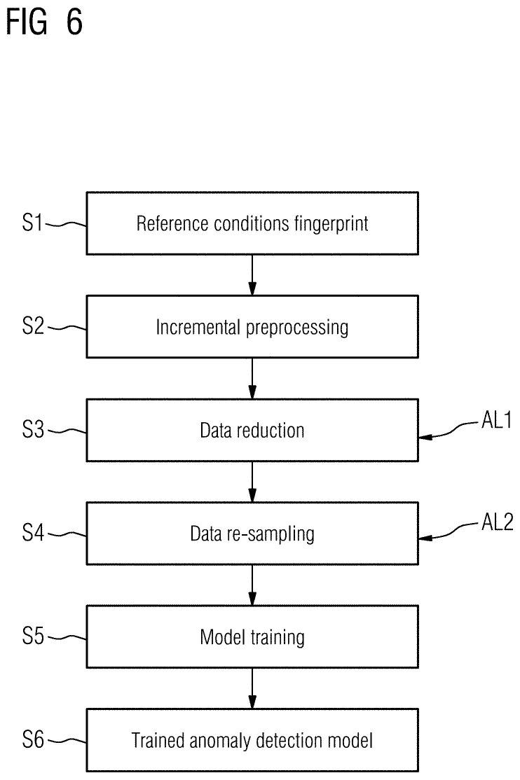

FIG. 6 shows exemplary method acts of incremental preprocessing, data reduction and/or re-sampling for training a machine learning model.

In act S1, a fingerprint is obtained. The fingerprint is given by input data that represents reference conditions of the operation of the converter.

In act S2, incremental preprocessing is performed. Therein, the input data is cleansed and scaled. Furthermore, the input data may be divided into batches as described herein in order to be (incrementally) processed by the edge device.

If the baseline measurement, e.g., the fingerprint, extends over a long period of time, it may not be possible to process it at once due to hardware limitations of the edge device, e.g., the limited memory and computational power of an edge device. Hence, the input data is processed incrementally in smaller batches and the results of the previous act are forwarded to next act. Preprocessing functions derived in this act may be saved to be used later for data reduction and will be applied on new data obtained during the application phase.

In act S3, data reduction is performed, e.g., by clustering the (pre-processed) input data and determining representative samples for each of the one or more clusters. The data reduction may be part of act S2 or may be performed subsequent to act S2.

The data reduction enables the use of a computing unit with reduced power. The reference measurement may cover a long period of time (days, weeks), whereby the amount of data becomes enormously large and may no longer be easily executed on a computing unit with limited resources as often encountered on the field level. This problem is solved by incremental data preprocessing, whereby the processing takes place in so-called batches, e.g., samples of operating parameters during predetermined time intervals. Therein, the batches are processed, e.g., according to the first clustering algorithm AL1, incrementally, e.g., one batch after the other, such as in a consecutive manner. This allows the previous preprocessing acts to be taken into account when processing a subsequent batch. The resulting characteristics of the input data are thus compressed and may be stored and later made available for subsequent processing acts.

A reduction in the amount of data is proposed to enable the training of a machine learning model using the memory and the processor of the edge device. To that end, it is proposed to make use of a first clustering algorithm AL1, such as BIRCH. This clustering enables a memory-efficient method of machine learning to iteratively reduce large amounts of data and at the same time maintain the data quality.

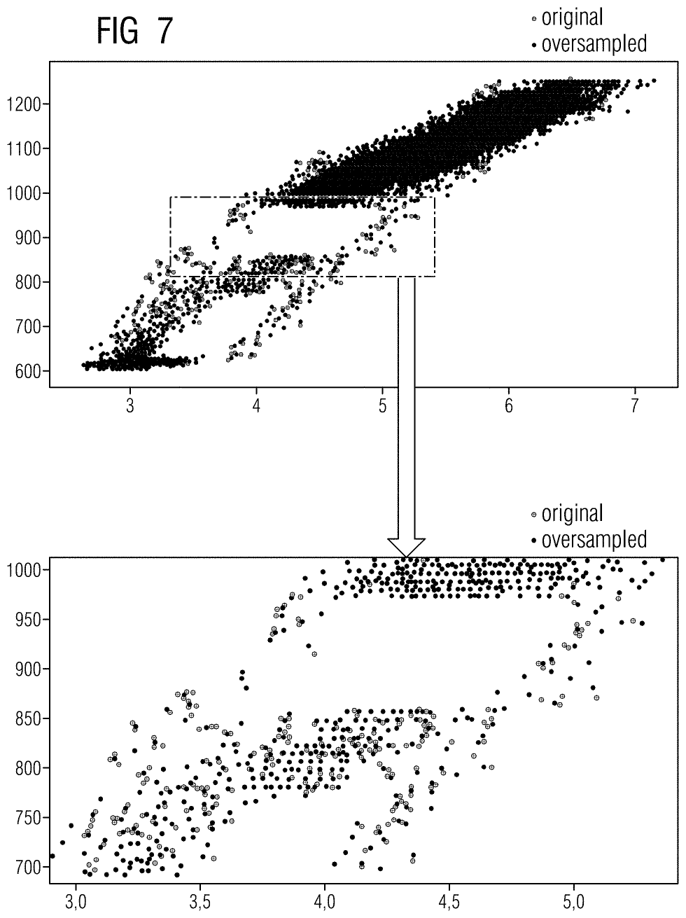

In act S4, data re-sampling is performed, e.g., in order to balance the representative samples. The input data, also referred to reference data or fingerprint, and thus also the reduced dataset (e.g., of the reference samples) may be imbalanced and non-uniform among all the operating states of the converter. Some operating states may occur more often than others. In particular, the transition between operating points occurs rarely in the input data and represents a minority “class” of operating states that occur less often than other operating states. To deal with this imbalance, the minority regions (e.g., low density regions of operating states transitions) are re-sampled. The minority regions may be determined based on a pre-clustering of the reduced dataset using a second clustering algorithm AL2, e.g., a mini-batch K-means clustering with a predefined number of clusters. The result of such a re-sampling is shown in FIG. 7.

The re-sampling is thus performed, e.g., after the data reduction in act S3, in order to compensate for underrepresented operating states, e.g., acceleration and delay ramps. The reduced data including the representative samples, referred to as “original” samples in FIG. 7, is first clustered into a second set of clusters, (e.g., 100 clusters), using a second clustering algorithm AL2, such as Mini Batch K-Means. The Mini Batch K-Means algorithm is a variant of the K-Means algorithm that uses mini batches to reduce computation time. Mini-batches may be subsets of data that are randomly selected, e.g., from the representative samples, in each training iteration. In the present case, the second clustering algorithm, e.g., MiniBatch K-means, may cluster the centroids R1, R2, R3 of C1, C2, C3, . . . into a new set of clusters, e.g., second set of clusters. This is done to identify underrepresented areas. The new set of clusters is then balanced/resampled, referred to as “oversampled” in FIG. 7. Because the clusters, e.g., first set of clusters, resulting from the first clustering algorithm may not uniformly be distributed or contain a different number of samples, the Mini Batch K-Means algorithm may determine the median value of the number of samples in each cluster. All clusters with fewer points than the median may then be randomly re-sampled, cf. “oversampled” samples in FIG. 7.

In addition to acceleration and deceleration ramps, there may be times of other underrepresented operating states, at which the drive system and the converter, respectively, operate less often, but represent a normal operating state for the drive system and the converter, respectively. In order to take such operating conditions into account for the purpose of anomaly detection, re-sampling is proposed. Re-sampling may make use of a second clustering algorithm AL2, which enables a conclusion about underrepresented operating states. As a result, all operating states, and the transitions between two operating states may be weighted equally.

In act S5, the machine learning model may be trained based on the resampled data set. Alternatively, the machine learning model may be trained on the data set as obtained after act S3, e.g., without the re-sampling of act S4. The anomaly detection may be considered as a one-class classification problem. For example, a One-Class SVM, support vector machine, may be used to train the anomaly detection model. Other machine learning models, e.g., isolation forest, deep neural networks, etc., may be used instead. The trained machine learning model is saved on the edge device and may be applied later on to new unseen data in the application phase.

FIG. 7 shows representative samples of the input data to which additional samples are added (re-sampled). The first image of FIG. 7 shows the original input data and the additional samples added to the original input data. The second image of FIG. 7 shows an excerpt of the first image which contains the representative samples of the input data and the additional samples added by re-sampling the representative samples.

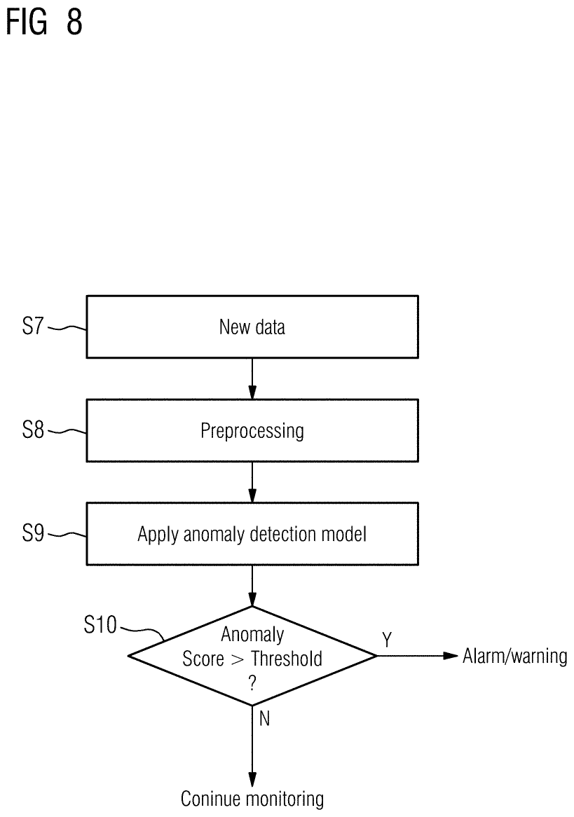

FIG. 8 shows exemplary method act when applying the machine learning model, e.g., during the application phase.

During the application phase new data is obtained from the converter in act S7. The new data represents the current operating state of the converter. The new data may be in the form of the input data as described in the above or may be continuously processed after being obtained and/or intermediately buffered in a memory of the edge device.

In act S8, pre-processing of the new data may be performed, e.g., in a consistent manner as described in act S2 above. This guarantees that the data is on the same scale as the data used for training the machine learning model.

In act S9, the new data may be input into the trained machine learning model which machine learning model serves for anomaly detection. The machine learning model may output an anomaly score based on which the state of the converter is determined. To that end, the anomaly score is compared to a threshold in act S10. As a result, an alarm or warning may be generated. If no abnormal operation or anomaly has been determined by the machine learning model monitoring may continue, e.g., by (pre-)processing further new data obtained from the converter.

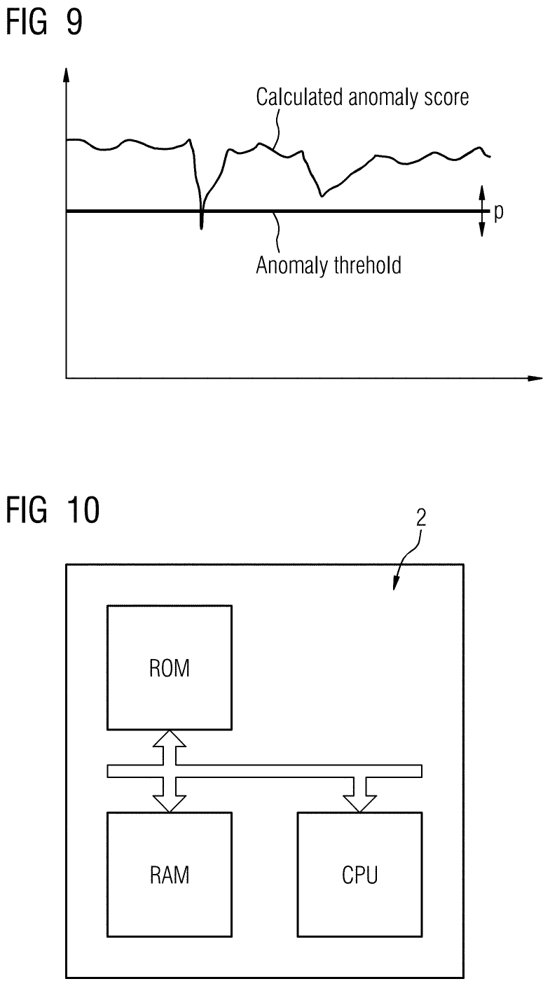

FIG. 9 shows an illustration of an anomaly score as output by the machine learning model and a pre-determined threshold p. The threshold p may be calculated during the training phase of the machine learning model. After the training phase is completed, the anomaly detection may be executed by the edge device. The output of the machine learning model and the analytics software application, respectively, is shown as a function of time. As a result, an alarm may be issued, e.g., to a user, if the anomaly scores exceeds the pre-determined threshold.

After the training phase, the threshold p will be set to a default value, e.g., of 0.5. It is recommended to start the anomaly detection with this threshold value and then iteratively approach the optimum setting. If too many anomalies are being detected, the threshold p may be lowered (p<0.5). If the drive system to be monitored, for example, is a critical part of the production, a higher sensitivity (p>0.5) may be helpful to detect all anomalies that occur during application phase. It is recommended to decrease or increase the threshold value in little steps, e.g., by ±0.05. The value of the threshold may need to be set for each drive system and/or converter individually. A transfer is only possible if the drive system is of the exact same design and workload (usage). But even in these cases, it is highly recommended to set the sensitivity factor p in the way that is described above.

Hence, the analytics software application may detect changes in the application characteristic which may be harmful for the drive system or lead to a lower performance or quality of the production or product.

The analytics software application is defined by two phases. Phase 1 includes learning and training to generate a machine learning model of the normative state of the drive system and/or converter, respectively. In Phase 2, the machine learning model is used to detect anomalies within the application. The analytics software application is not specified for a specific drive system or customer application. It may be used for any application and may be configured according to that.

Further advantageous acts are provided in the following:

After obtaining a first batch of input data, a second batch of input data may be obtained, e.g., by the edge device. The number of samples in the second batch of input data may be reduced by clustering the second batch, e.g., according to the first clustering algorithm. The first set of clusters may be updated, e.g., by updating the clustering feature tree, which was created by applying the first clustering algorithm to the first batch. Similarly, it may be proceeded with a third, fourth etc. and for that matter all batches of the input data. That is, the n^{th} batch may be clustered by updating the previously obtained first set of clusters. Hence, an iterative clustering of the batches of input data is proposed.

Furthermore, the samples of the first batch and/or second batch may thus be clustered into the first set of clusters. Therein, a maximum cluster radius for each cluster in the first set of clusters is determined based on a pre-set maximum distance between two samples, e.g., a given percentage, e.g., 0.25%, of a nominal speed of the converter. Thereby the amount of data reduction and the resolution up to which a clustering is performed may be controlled. This may be particularly useful for adapting the amount of data for training the machine learning model to the storage capacity of the second memory of the edge device. Furthermore, making the cluster radius dependent on the nominal speed of the converter allows for adapting the resolution of the condition monitoring to the specifics of the application of the converter. The nominal speed is the speed at which a motor of the drive system reaches its maximum power.

It is further proposed to record the input data, (e.g., on a first memory, such as a mass storage memory), to create the first batch, and, e.g., the second batch, from the input data, e.g., by aggregating successive samples of the input data into the first and/or second batch, respectively, and to store the first batch, and, e.g., the second batch on a second memory, (such as a volatile memory), wherein in particular the input data includes a data volume that exceeds a storage capacity of the second memory and/or wherein a data volume of the first and/or second batch is configured to the storage capacity of the second memory. Thereby the iterative processing of the input data by way of one or more batches, the input data is divided into, is achieved.

It is further proposed to overwrite, after reducing the number of samples of the first batch, at least in part the first batch of input data in the second memory unit with the second batch of input data. The reduction of samples may be performed accordingly using the first clustering algorithm and by determining a representative sample of for each of the clusters created. The first batch that is stored in the second memory may then at least in part be overwritten by the samples of second batch. Thereby, the storage capacity of the second memory is reused for the iterative processing of the batches created from the input data.

It is further proposed to split the input data into a plurality of batches by aggregating successive samples. As described above, the splitting may be performed by dividing the input data into the multiple batches, e.g., according to a given number of samples and/or according to a period of time.

It is further proposed to determine a centroid of each cluster of the first set of clusters and use the centroid as the representative sample for each cluster of the first set of clusters. Thereby a plurality of samples of a cluster may be reduced to a single sample. This representative sample includes the information necessary to train the machine learning model.

It is further proposed to cluster the representative samples, such as according to a second clustering algorithm, e.g., Mini Batch K-means, into a second set of clusters and to balance the number of representative samples in each cluster of the second set of clusters, e.g., by adding or removing further representative samples to a cluster of the second set of clusters.

It is further proposed to use the operating parameters of the converter, wherein the operating parameters of the converter include one or more of the following: a speed setpoint of the converter; an actual, (e.g., unsmoothed), speed value; an actual, (e.g., absolute and/or unsmoothed), current value; an actual, (e.g., unsmoothed), phase current; an actual DC link voltage; an output voltage; an actual torque-generating current value; and/or an actual, (e.g., unsmoothed), torque value.

It is further proposed to record input data by cyclically reading, (e.g., subsampling), the operating parameters of the converter by a device communicatively coupled to the converter. The device communicatively coupled to the converter may be an edge device as described in the above. The subsampling of the operating parameters of the converter reduces the amount of data for training the machine learning model. The clustering of the samples in the batches further reduces the amount of data used for training the machine learning model.

It is further proposed to determine an abnormal operating state of the converter or an anomaly in the operation of the converter based on the trained machine learning model, and to output an alert indicating the abnormal operating state and/or the anomaly. The alert may be an alarm or a warning which is displayed, e.g., on a user interface.

It is further proposed that the input data includes samples of a plurality of operating parameters of the converter and to determine, e.g., based on an error indicator, (such as a (mis)classification error of the machine learning model), a first operating parameter from the plurality of operating parameters potentially responsible for the abnormal operating state and/or the anomaly, and to adjust the first operating parameter of the converter. The error indicator may be a mean-squared error. For example, the machine learning model may be a (one class) classifier, which determines continuous anomaly scores, which are converted to a class label, e.g., “anomaly,” in the present case, using a suitable threshold. For example, a support vector machine, SVM, may be used for the classification. The error indicator and/or the misclassification error may be based on a measure of feature importance, e.g. SHAP values, of the machine learning model. The SVM may be trained based on the fingerprint, of which all samples belong to a single class, e.g., the normal operation. Hence, the machine learning model is trained on normal operating conditions, so that when a new data is input, the machine learning model is able to determine whether an anomaly is present in the newly input data. Then the operating parameter contributing the most to the mean square error may be identified. On that basis, the operating parameter potentially responsible for the anomaly may be identified. Subsequently, corrective action may be taken by adjusting the operating parameter potentially responsible for the anomaly. Such adjustment may be made automatically by controlling the or by a user input.

It is thus further proposed to adjust the speed of the converter in case an abnormal operating state or an anomaly is determined, e.g., by adjusting the speed setpoint of the converter, or to adjust a DC link voltage of the converter, e.g., by (de-) coupling the converter to/from a voltage line.

It is further proposed to use input data representing one or more nominal operating states of the converter.

It is further proposed to use the trained machine learning model in order to perform condition monitoring of the converter.

Furthermore, a trained machine learning model is proposed as obtained by training in accordance with any one of the embodiments described herein.

Finally, a device, (e.g., including a first and/or a second memory unit), is proposed.

FIG. 10 shows a device including a processing unit and a first and a second memory. The device shown may be an edge device, e.g., as described in connection with FIG. 1.

The input data may be obtained from the converter and stored in the first memory ROM. Thereupon, the input data may be split or divided in a single operation or successively into a plurality of batches. A first batch may then be transmitted to the second memory, where it is stored. The processor may then access the first batch in the second memory and perform the acts as described herein, in particular in connection with FIGS. 3 to 6. Subsequently, a second batch may be transmitted from the first memory to the second memory, where the second batch is stored, e.g., by overwriting the first batch (at least in part). The acts as described herein, in particular in connection with FIGS. 3 to 6, may be performed by the processor for the second batch and/or further batches. The further batches may be handled in the same way in order obtain a trained machine learning model. The machine learning model may also be stored in the edge device, e.g., in the first memory for later usage or in the second memory for execution during the application phase.

The advantages of the proposed solution lie in the individual usability of anomaly detection for the user. The reference measurement allows each user to customize the anomaly detection individually. In addition, the sensitivity may be individually adjusted. Error and warning thresholds are automatically preset on the basis of the reference measurement and thus directly take into account the special features of each drive system and converter, respectively, but may also be adapted by the user if necessary. By reducing the data accordingly, the clustering algorithm or the machine learning model may also be executed on less performant computing units. The algorithm only reduces the amount of data but not its quality and significance. The underrepresented samples in the data, which may be found in drive system during acceleration and deceleration processes, are also specifically taken into account. These operating states are taken into account for the purpose of anomaly detection as well as a normal operating states of the drive system and converter, respectively.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the disclosure has been illustrated and described in detail with the help of the embodiments, the disclosure is not limited to the disclosed examples. Other variations may be deduced by those skilled in the art without leaving the scope of protection of the claimed disclosure.

1. A computer-implemented method of providing a machine learning model for condition monitoring of an electric power converter, the method comprising:
obtaining a first batch of input data, wherein the first batch of input data comprises a plurality of samples of one or more operating parameters of the electric power converter during at least one operating state of the electric power converter;
reducing a number of samples of the plurality of samples of the first batch by clustering the plurality of samples of the first batch into a first set of clusters and determining at least one representative sample for each cluster of the first set of clusters; and
providing the representative samples for training the machine learning model and/or training the machine learning model based on the representative samples.

2. The method of claim 1, wherein the reducing of the number of samples is performed using a first clustering algorithm based on a clustering feature tree.

3. The method of claim 1, further comprising:
obtaining a second batch of input data; and
reducing a number of samples in the second batch of input data by clustering the second batch.

4. The method of claim 3, wherein the clustering of the second batch is performed by updating the first set of clusters by updating a clustering feature tree created by the first batch.

5. The method of claim 1, further comprising:
clustering the plurality of samples of the first batch and/or a plurality of samples of a second batch into the first set of clusters,
wherein a maximum cluster radius for each cluster in the first set of clusters is determined based on a pre-set maximum distance between two samples of a nominal speed of the electric power converter.

6. The method of claim 1, further comprising:
recording the input data on a first memory;
creating the first batch and, optionally, a second batch, from the input data by aggregating successive samples of the input data into the first batch and/or the second batch, respectively; and
storing the first batch, and optionally, the second batch, on a second memory,
wherein the input data comprises a data volume that exceeds a storage capacity of the second memory, and/or
wherein a data volume of the first batch and/or the second batch is configured to the storage capacity of the second memory.

7. The method of claim 6, wherein the first memory is a mass storage memory, and
wherein the second memory is a volatile memory.

8. The method of claim 6, further comprising:
overwriting, after reducing the plurality of samples of the first batch, at least a part of the first batch of input data in the second memory with the second batch of input data.

9. The method of claim 8, further comprising:
splitting the input data into a plurality of batches by aggregating successive samples.

10. The method of claim 1, further comprising:
determining a centroid of each cluster of the first set of clusters and using the centroid as the representative sample for each cluster of the first set of clusters.

11. The method of claim 1, further comprising:
clustering the representative samples, according to a second clustering algorithm, into a second set of clusters; and
balancing a number of representative samples in each cluster of the second set of clusters by adding or removing further representative samples to a cluster of the second set of clusters.

12. The method of claim 1, wherein the operating parameters of the electric power converter comprise a speed setpoint of the electric power converter, an actual speed value, an actual current value, an actual phase current, an actual DC link voltage, an output voltage, an actual torque-generating current value, an actual, preferably unsmoothed, torque value, or a combination thereof.

13. The method of claim 1, further comprising:
recording the input data by cyclically reading the operating parameters of the electric power converter by a device communicatively coupled to the electric power converter; and/or
determining an abnormal operating state of the electric power converter or an anomaly in the operation of the electric power converter based on the trained machine learning model; and
outputting an alert indicating the abnormal operating state and/or the anomaly.

14. The method of claim 13, wherein the recording of the input data is performed by subsampling the operating parameters.

15. The method of claim 13, wherein the input data comprises samples of a plurality of operating parameters of the electric power converter, and
wherein the method further comprises:
determining, based on an error indicator, a first operating parameter from the plurality of operating parameters potentially responsible for the abnormal operating state and/or the anomaly; and
adjusting the first operating parameter of the electric power converter.

16. The method of claim 15, wherein the error indicator is a (mis)classification error of the machine learning model.

17. The method of claim 1, further comprising:
adjusting a speed of the electric power converter when an abnormal operating state or an anomaly is determined by adjusting a speed setpoint of the electric power converter, or
adjusting a DC link voltage of the electric power converter by coupling the electric power converter to a voltage line or decoupling the electric power converter from the voltage line.

18. The method of claim 1, wherein the input data represents one or more nominal operating states of the electric power converter.

19. The method of claim 1, further comprising:
performing condition monitoring of the electric power converter using the trained machine learning model.

20. A non-transitory computer readable medium comprising:
a trained machine learning model that has been trained by:
obtaining a first batch of input data, wherein the first batch of input data comprises a plurality of samples of one or more operating parameters of an electric power converter during at least one operating state of the electric power converter;
reducing a number of samples of the plurality of samples of the first batch by clustering the plurality of samples of the first batch into a first set of clusters and determining at least one representative sample for each cluster of the first set of clusters; and
training the machine learning model based on the representative samples.

21. A device comprising:
at least one processor and memory configured to:
obtain a first batch of input data, wherein the first batch of input data comprises a plurality of samples of one or more operating parameters of an electric power converter during at least one operating state of the electric power converter;
reduce a number of samples of the plurality of samples of the first batch by clustering the plurality of samples of the first batch into a first set of clusters and determining at least one representative sample for each cluster of the first set of clusters; and
provide the representative samples for training a machine learning model and/or train the machine learning model based on the representative samples.
